(19) United States
(12) Patent Application Publication
(10) Pub. No.: US 2018/0339570 A1
(43) Pub. Date: Nov. 29, 2018

(54) HVAC SYSTEM OF VEHICLE

(71) Applicants: Hyundai Motor Company, Seoul (KR); Kia Motors Corporation, Seoul (KR)

(72) Inventors: Sang Shin LEE, Suwon-si (KR); Jae Woo PARK, Ansan-si (KR); So Yoon PARK, Suwon-si (KR); Man Ju OH, Yongin-si (KR); Jae Woong KIM, Hwaseong-si (KR); So La CHUNG, Seoul (KR)

(73) Assignees: Hyundai Motor Company, Seoul (KR); Kia Motors Corporation, Seoul (KR)

(21) Appl. No.: 15/809,498

(22) Filed: Nov. 10, 2017

(30) Foreign Application Priority Data
May 25, 2017 (KR) 10-2017-0064824

(51) Int. Cl. B60H 1/00; B60H 1/14; B60H 1/22

(52) U.S. Cl. CPC B60H 1/00278; B60H 1/143; B60H 2001/00307; B60H 1/00392; B60H 1/00885; B60H 1/2215

(57) ABSTRACT

A heating, ventilation, and air conditioning (HVAC) system for a vehicle, may include external air cooling line configured to circulate first cooling water through a first radiator, a main valve and a high-voltage battery core, a cooling/heating line having a first end branching from the main valve and a second end connected to a downstream point of the high-voltage battery core, the cooling/heating line being configured to enable the high-voltage battery core to be heated or cooled by a heat exchanger or an electric heater, and a controller configured to selectively control at least one of the main value, the heat exchanger and the electric heater to cause the first cooling water to circulate through the external air cooling line or the cooling/heating line to perform heat transfer in the heat exchanger or the electric heater when cooling or heating of the high-voltage battery core is needed.

### CROSS-REFERENCE(S) TO RELATED APPLICATIONS

The present application claims priority to Korean Patent Application No. 10-2017-0064824, filed on May 25, 2017, the entire contents of which is incorporated herein for all purposes by this reference.

### BACKGROUND OF THE INVENTION

### Field of the Invention

The present invention relates to a heating, ventilation, and air conditioning (HVAC) system for a vehicle, and more particularly, to an HVAC for a vehicle which raises the temperature of a high-voltage battery using cooling water heated while cooling the electric component side during winter to minimize energy transfer, reduce energy consumption, and extend the range of the vehicle.

### Description of Related Art

Recently, electric vehicles have emerged as a social issue to implement eco-friendly technologies and solve the problem of energy depletion. An electric vehicle operates by use of a motor that receives electricity from a battery and outputs power. Therefore, electric vehicles are drawing attention as an eco-friendly vehicle since the vehicle emits no carbon dioxide, generates very low noise, and the energy efficiency of the motor is higher than that of an engine.

In realizing such an electric vehicle, a core technology is related to a battery module, and research on a lightweight and compact battery with short charging time has recently been conducted. The battery module can maintain optimum performance and long service life when it is used under optimal temperature conditions. However, it is currently difficult to use the battery module under the optimal temperature conditions due to the heat generated while driving and the temperature change of the external environment.

Since the electric vehicle does not have a source of waste heat to be generated when combustion occurs in an engine including an internal combustion engine, it is necessary to heat the internal of the vehicle in winter using an electric heating device, and to heat to improve the charge and discharge performance of the battery during a very cold weather. For the present reason, a separate cooling water-heated electric heater is used. That is, to maintain the optimal temperature conditions for the battery module, a cooling/heating system configured for controlling the temperature of the battery module is adopted separately from the cooling/heating system for air conditioning of the vehicle internal. In other words, two independent cooling/heating systems are provided: a first system is used for internal cooling and heating, and a second system is used for temperature control of the battery module.

However, when the systems are operated in the present way, energy cannot be efficiently managed, and accordingly, the vehicle cannot be operated for a long distance because of the short cruising range. Further, the travel distance is reduced by approximately 30% during summer cooling and by approximately 40% or more during winter heating, worsening the problem of heating in the wintertime, which is not encountered in conventional internal combustion engines.

In winter, the amount of heat generated from the electric components is greater than that of heat generated from the high-voltage battery, and an area of the high-voltage battery contacting the air is large. Accordingly, the amount of cooling becomes greater than the amount of generated heat of the high-voltage battery due to the external air temperature, and thus an appropriate temperature for operation of the high-voltage battery is not satisfied which results in lowered output of the high-voltage battery. Therefore, during winter, it is necessary to raise the temperature of the high-voltage battery while driving to efficiently manage the high-voltage battery.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a HVAC system for a vehicle which is configured for efficiently managing energy required for internal heating of a vehicle and increase in battery temperature, extending a driving range and reducing production costs of the vehicle.

In accordance with an aspect of the present invention, the above and other objects can be accomplished by the provision of a heating, ventilation, and air conditioning (HVAC) system for a vehicle, including an external air cooling line configured to circulate first cooling water through a first radiator, a main valve and a high-voltage battery core, a cooling/heating line having a first end portion branching from the main valve and opposite second end portion connected to a downstream point of the high-voltage battery core, the cooling/heating line being configured to enable the high-voltage battery core to be heated or cooled by a heat exchanger or an electric heater, and a controller configured to selectively control at least one of the main value, the heat exchanger, and the electric heater to cause the first cooling water to circulate through the external air cooling line or the cooling/heating line to perform heat transfer in the heat exchanger or the electric heater when cooling or heating of the high-voltage battery core is needed.

Each of the external air cooling line and the cooling/heating line may form an independent flow channel, and the cooling/heating line may share a portion of the external air cooling line including the high-voltage battery core of the external air cooling line to form a closed loop.

The main valve may be a three-way valve, and include a first port on a side of the first radiator, a second port on a side of the cooling/heating line, and a third port on a side of the high-voltage battery core, wherein, when internal cooling and cooling of the high-voltage battery core are simultaneously needed, the controller may perform a control operation to close the first port of the main valve and cause the first cooling water to circulate through the cooling/heating line to transfer heat with the heat exchanger, wherein the internal cooling and the cooling of the high-voltage battery core are performed simultaneously.

The main valve may be a three-way valve, and include a first port on a side of a first radiator, a second port on a side of the cooling/heating line, and a third port on a side of the high-voltage battery core, wherein, when a temperature of the high-voltage battery core needs to be raised, the controller may perform a control operation to close the first port of the main valve and cause the first cooling water to circulate through the cooling/heating line to transfer heat with the electric heater, wherein cooling of the high-voltage battery core is performed at the same time.

The external air cooling line may be provided with a first pump, and the controller may be configured to drive or stop the first pump.

The first pump may be disposed between a downstream point of the main valve and the opposite end portion of the cooling/heating line.

The cooling/heating line may be configured to transfer heat with an internal air-conditioning refrigerant line through the heat exchanger, wherein the first cooling water having transferred heat with the refrigerant line cools the high-voltage battery core.

The refrigerant line may be provided with an auxiliary valve configured for supplying or blocking a refrigerant to allow a refrigerant of the refrigerant line to transfer heat with the first cooling water of the cooling/heating line in the heat exchanger.

The main valve may be an on-off valve disposed at a first end portion of the cooling/heating line on a side of the first radiator corresponding to an upstream point of the stream of the first cooling water, and may be controlled to be opened or closed by the controller.

The HVAC system may further include an electric component cooling line configured to allow second cooling water to independently circulate through a second radiator and an electric component core.

The electric component cooling line may be provided with a second pump, and the controller may be configured drive or stop the second pump.

When a cooling mode is set, the controller may be configured to control the main valve to circulate the first cooling water in the cooling/heating line and control the first cooling water cooled by heat transfer through the heat exchanger to cool the high-voltage battery core.

When a heating mode is set, the controller may be configured to control the main valve to circulate the first cooling water in the cooling/heating line and control the first cooling water heated by heat transfer through the electric heater to raise a temperature of the high-voltage battery core.

When an external air heating/cooling mode is determined, the controller may be configured to control the main valve to circulate the first cooling water in the external air cooling line and control the first cooling water cooled through a first radiator to cool the high-voltage battery core.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a diagram illustrating a cooling mode of a HVAC system for a vehicle according to an exemplary embodiment of the present invention;

FIG. 2 is a diagram illustrating a heating mode of the high-voltage battery of FIG. 1;

FIG. 3 is a diagram illustrating a natural cooling mode of FIG. 1;

FIG. 4 is a diagram illustrating a cooling mode of a HVAC system for a vehicle according to another exemplary embodiment of the present invention; and

FIG. 5 is a diagram illustrating the natural cooling mode of FIG. 4.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

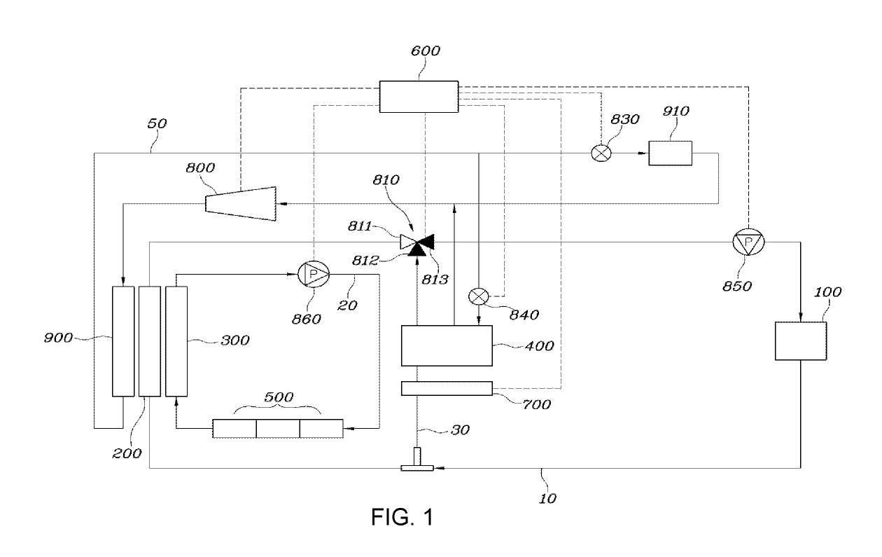

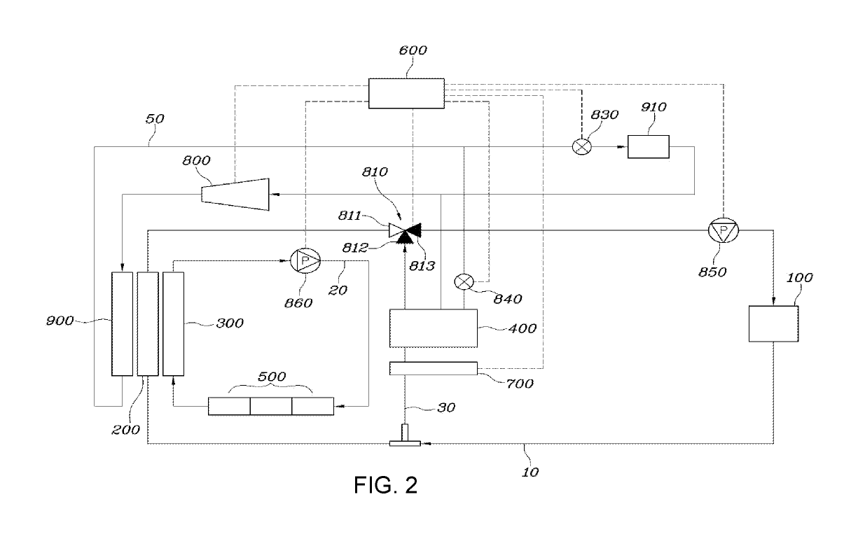

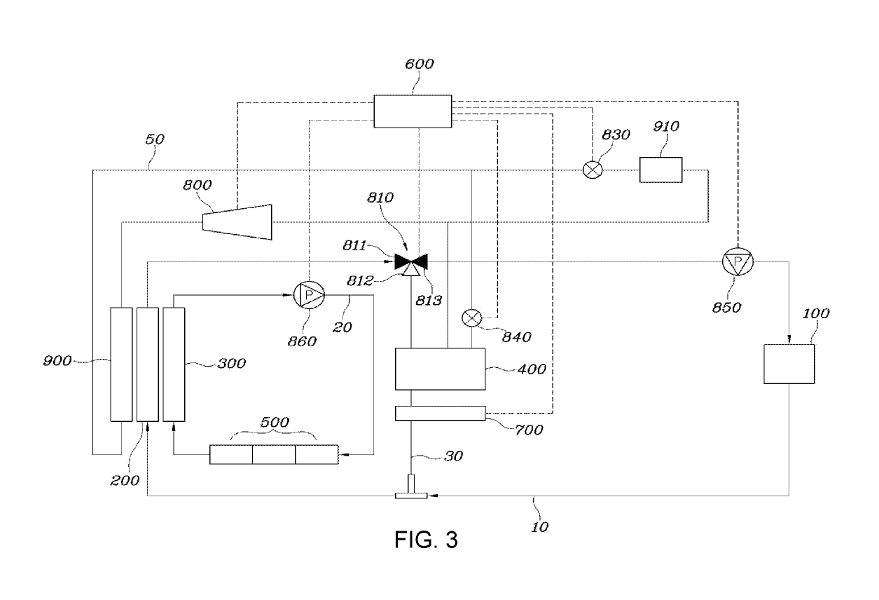

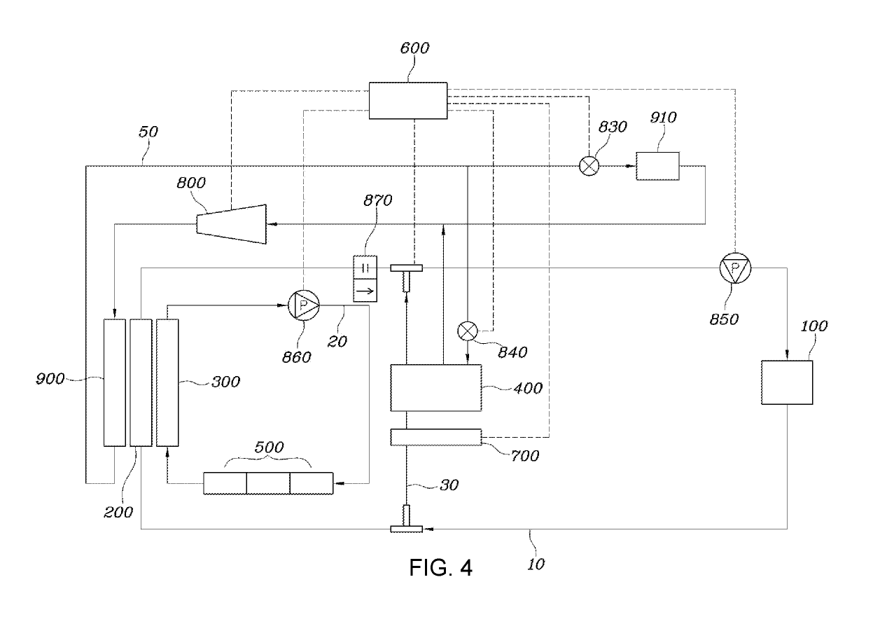

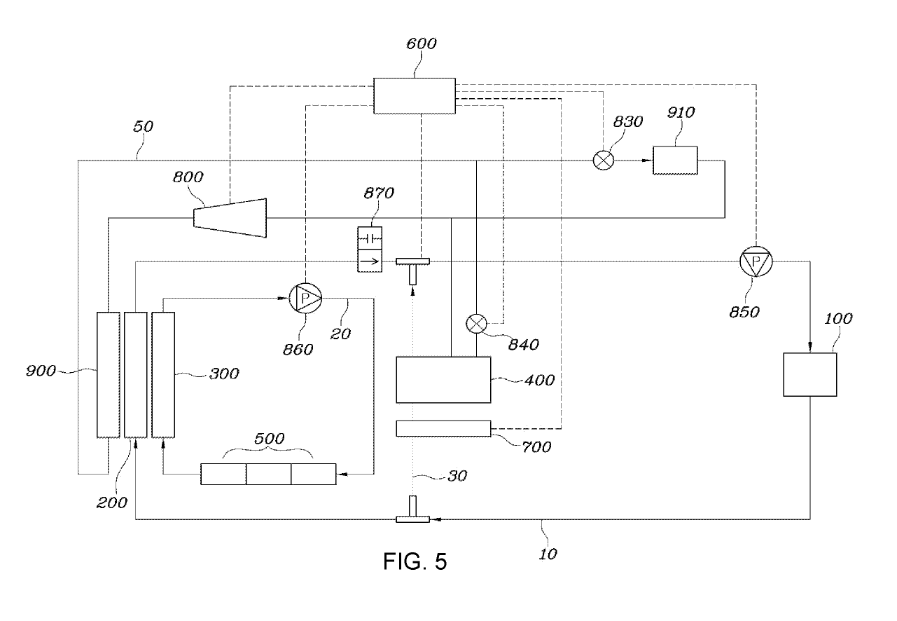

FIG. 1 is a diagram illustrating a cooling mode of an HVAC system for a vehicle according to an exemplary embodiment of the present invention, FIG. 2 is a diagram illustrating a heating mode of the high-voltage battery of FIG. 1, and FIG. 3 is a diagram illustrating a natural cooling mode of FIG. 1. FIG. 4 is a diagram illustrating a cooling mode of an HVAC system for a vehicle according to another exemplary embodiment of the present invention, and FIG. 5 is a diagram illustrating the natural cooling mode of FIG. 4.

The HVAC system for a vehicle according to an exemplary embodiment of the present invention includes an external air cooling line 10 configured to circulate first cooling water through a first radiator 200, a main valve 810 and a high-voltage battery core 100; a cooling/heating line 30 having one end portion branching from the main valve 810 and an opposite end portion connected to a downstream point of the high-voltage battery core 100, the cooling/heating line 30 being configured to enable the high-voltage battery core 100 to be heated or cooled by a heat exchanger 400 or an electric heater 700; a controller 600 is configured to selectively control at least one of the main valve 810, the heat exchanger 400, and the electric heater 700 to cause the first cooling water to circulate through the external air cooling line 10 or the cooling/heating line 300 to perform heat transfer in the heat exchanger 400 or the electric heater 700 when cooling or heating of the high-voltage battery core 100 is needed.

The external air cooling line 10 is disposed such that the first cooling water circulates through the first radiator 200, the main valve 810 and the high-voltage battery core 100, and is also provided with a first pump 850 which is controlled by the controller 600 to operate or stop the first pump 850. Here, the first pump 850 is disposed on the external air cooling line 10 and disposed between the downstream point of the main valve 810 and the second end portion of the cooling/heating line 30. The first pump 850 may be disposed either between the main valve 810 and the high-voltage battery core 100 or between the high-voltage battery core 100 and the second end portion of the cooling/heating line 30. Therefore, the first cooling water may have an effect both when the first cooling water circulates through the external air cooling line 10 via the first radiator 200, and when the first cooling water circulates through the cooling/heating line 30.

The heating/cooling line 30 has one end portion branching from the main valve 810 and an opposite end portion connected to a downstream point of the high-voltage battery core 100. The cooling/heating line 30 is configured such that the high-voltage battery core 100 can be heated or cooled by the heat exchanger 400 or the electric heater 700. Any of the heat exchanger 400 and the electric heater 700 can be disposed upstream of the cooling/heating line 30. Each of the external air cooling line 10 and the cooling/heating line 30 forms an independent flow channel, and the cooling/heating line 30 shares a portion of the external air cooling line 10 including the high-voltage battery core 100 to form a closed loop. That is, the cooling/heating line 30 includes the high-voltage battery core 100 and the first pump 850, wherein the first cooling water forms a closed loop and circulates therein.

As shown in FIG. 1, FIG. 2, and FIG. 3, the main valve 810 is a three-way valve, and includes a first port 811 on the side of the first radiator 200, a second port 812 on the side of the cooling/heating line 30, and a third port 813 on the side of the high-voltage battery core 100. When simultaneous internal cooling and cooling of the high-voltage battery core 100 are needed, the controller 600 performs a control operation to close the first port 811 of the main valve 810 and cause the first cooling water to circulate through the cooling/heating line 30 to transfer heat with the heat exchanger 400, wherein internal cooling and cooling of the high-voltage battery core 100 are performed simultaneously. In addition, when the temperature of the high-voltage battery core 100 needs to be raised, the controller 600 performs a control operation to close the first port 811 of the main valve 810 and cause the first cooling water to circulate through the cooling/heating line 30 to transfer heat with the electric heater 700, wherein cooling of the high-voltage battery core is performed at the same time.

The cooling/heating line 30 is configured to transfer heat with an internal air-conditioning refrigerant line 50 through the heat exchanger 400. The refrigerant line 50 includes a compressor 800, an air-cooled condenser 900, a shutoff valve 830, and an evaporator 910. The refrigerant line 50 has a line branching therefrom to allow the refrigerant in the refrigerant line 50 to transfer heat in the heat exchanger 400. The branch line is provided with an auxiliary valve 840 controlled by the controller 600 to supply or block flow of the refrigerant to the heat exchanger 400. Accordingly, in cooling the internal and the high-voltage battery core 100, the first cooling water having performed heat transfer with the refrigerant line 50 cools the high-voltage battery core 100.

As shown in FIG. 4 and FIG. 5, the main valve 810 may be an on-off valve 870 disposed at one end portion of the cooling/heating line 30 on a side of the first radiator corresponding to an upstream point of flow of the first cooling water, and may be controlled to be open or closed by the controller. That is, the opposite end portion of the cooling/heating line 30 is provided with a tube which allows a typical fluid to flow therethrough and branches into three directions, and the on-off valve 870 is disposed on an introduction port side of the tube through which the first cooling water flows to the high-voltage battery core 100 wherein the on/off state of the on-off valve 870 is controlled by the controller 600. Accordingly, the external air heating/cooling mode can be implemented.

Alternatively, the main valve 810 may form a valve that can be opened or closed by the controller 600 in the tube on the introduction port side. The configuration of the main valve 810 is not limited to the above description, and those skilled in the art can easily realize a design change thereof when the design involves controlling the introduction port to be opened or closed. Accordingly, even when the controller 600 controls the on-off valve 870 to be opened to open the introduction port, most of the first cooling water flows to the external air cooling line 10 configured as a main flow channel rather to the cooling/heating line 30 configured as a sub-flow channel because the flow channel may be curved in a tube formed at the opposite end portion of the cooling/heating line 30, and the heat exchanger 400 and the electric heater 700 serve as resistors. Therefore, the high-voltage battery core 100 can be cooled while a minimal amount of energy for driving the first pump 850 is consumed.

In addition to the external air cooling line 10, the cooling/heating line 30, and the refrigerant line 50, the HVAC system of the present invention further includes an electric component cooling line 20 configured to allow second cooling water to independently circulate through a second radiator 300 and an electric component core 500. The electric component cooling line 20 is provided with a second pump 860 and the controller 600 drives or stops the second pump 860. Here, the second pump 860 can be disposed anywhere in the closed loop.

Hereinafter, flow of the cooling water in each mode will be discussed with reference to the drawings.

FIG. 1 illustrates a cooling mode according to an exemplary embodiment of the present invention. In the cooling mode, the controller 600 performs a control operation to connect the second port 812 and the third port 813 of the main valve 810 and to close the first port 811 to form a closed loop while sharing a portion of the external air cooling line 10 with the cooling/heating line 30. At the present time, the first cooling water cannot circulate to the side of the first radiator 200. Since the internal of the vehicle also needs to be cooled at the present time, the controller 600 also controls the shutoff valve 830 and the auxiliary valve 840. Accordingly, the external air cooling line 10 is connected to the cooling/heating line 30 and the internal air-conditioning refrigerant line 50. The first cooling water cooled by heat transfer with the refrigerant in the refrigerant line 50 through the heat exchanger 400 flows into the high-voltage battery core 100 via the main valve 810 and the first pump 850 along the cooling/heating line 30 to cool the high-voltage battery core 100. At the present time, in the electric component cooling line 20 the second cooling water is cooled in the second radiator 300 and then supplied to the electric component core 500 through the second pump 860 to cool the electric component core 500. Accordingly, in the cooling mode of FIG. 1, the controller 600 consumes energy for controlling the valves, energy for driving the pump, and energy for driving the air conditioning system.

FIG. 2 is a diagram illustrating a heating mode according to an exemplary embodiment of the present invention. In the heating mode, the controller 600 performs a control operation to connect the second port 812 and the third port 813 of the main valve 810 and to close the first port 811, connecting the external air cooling line 10 and the cooling/heating line 30. At the present time, the first cooling water cannot circulate through the first radiator 200. Since the internal volume of the vehicle needs to be heated at the present time, the controller 600 also controls the shutoff valve 830 and the auxiliary valve 840 wherein the external air cooling line 10 is not connected to the internal air-conditioning refrigerant line 50, but drives the electric heater 700 to raise the temperature of the first cooling water. Accordingly, the first cooling water heated through the electric heater 700 flows into the high-voltage battery core 100 via the main valve 810 and the first pump 850 to raise the temperature of the high-voltage battery core 100. At the present time, in the electric component cooling line 20 the second cooling water is cooled in the second radiator 300 and then supplied to the electric component core 500 through the second pump 860 to cool the electric component core 500. Accordingly, in the heating mode of FIG. 2, the controller 600 consumes energy for controlling the valves and for driving the pump.

FIG. 3 is a diagram illustrating an external air heating/cooling mode according to an exemplary embodiment of the present invention. In the external air heating/cooling mode, the controller 600 performs a control operation to connect the first port 811 and the third port 813 of the main valve 810 and to close the second port 812, separating the external air cooling line 10 and the cooling/heating line 30. At the present time, heat transfer with the refrigerant in the internal air-conditioning refrigerant line 50 does not occur through the heat exchanger 400. Accordingly, after the first cooling water is cooled through the first radiator 200 by the external air temperature, the first cooling water is controlled to circulate in the external air cooling line to cool the high-voltage battery core 100 via the first pump 850 and then return to the first radiator 200. At the present time, in the electric component cooling line 20 the second cooling water is cooled in the second radiator 300 and then supplied to the electric component core 500 through the second pump 860 to cool the electric component core 500. Accordingly, in the external air heating/cooling mode of FIG. 3, only the energy with which the controller 600 drives the pump is consumed.

FIG. 4 is a diagram illustrating a cooling mode according to another exemplary embodiment of the present invention. In the cooling mode, the controller 600 performs a control operation to close the on-off valve 870 to form a closed loop by sharing a portion of the external air cooling line 10 with the cooling/heating line 30. Since the internal of the vehicle also needs to be cooled at the present time, the controller 600 also controls the shutoff valve 830 and the auxiliary valve 840. Accordingly, the external air cooling line 10 is connected to the cooling/heating line 30 and the internal air-conditioning refrigerant line 50. The first cooling water cooled by heat transfer with the refrigerant in the refrigerant line 50 through the heat exchanger 400 flows into the high-voltage battery core 100 via the main valve 810 and the first pump 850 along the cooling/heating line 30 to cool the high-voltage battery core 100. At the present time, in the electric component cooling line 20 the second cooling water is cooled in the second radiator 300 and then supplied to the electric component core 500 through the second pump 860 to cool the electric component core 500. Accordingly, in the cooling mode of FIG. 4, the controller 600 consumes energy for controlling the valves, energy for driving the pump, and energy for driving the air conditioning system.

FIG. 5 is a diagram illustrating an external air heating/cooling mode according to another exemplary embodiment of the present invention. In the external air heating/cooling mode, the controller 600 controls the on-off valve 870 to be opened. At the present time, heat transfer with the refrigerant in the internal air-conditioning refrigerant line 50 does not occur through the heat exchanger 400. Accordingly, after the first cooling water is cooled through the first radiator 200 by the external air temperature, the first cooling water is controlled to circulate in the external air cooling line to cool the high-voltage battery core 100 via the first pump 850 and then return to the first radiator 200. In other words, even when the controller 600 controls the on-off valve 870 to be opened to open the introduction port, most of the first cooling water flows to the external air cooling line 10 configured as a main flow channel rather than the cooling/heating line 30 configured as a sub-flow channel because the flow channel may be curved in a tube formed at the second end portion of the cooling/heating line 30, and the heat exchanger 400 and the electric heater 700 serve as resistors. Therefore, the high-voltage battery core 100 can be cooled while a minimal amount of energy for driving the first pump 850 is consumed. At the present time, in the electric component cooling line 20 the second cooling water is cooled in the second radiator 300 and then supplied to the electric component core 500 through the second pump 860 to cool the electric component core 500. Therefore, in the external air heating/cooling mode of FIG. 5, only the energy with which the controller 600 drives the pump is consumed.

As is apparent from the above description, according to a heating, ventilation, and air conditioning (HVAC) system for a vehicle configured as described above, since the high-voltage battery core is preliminarily cooled in an external air heating/cooling mode by the external air, entry into the cooling mode for use of the air conditioning system can be suppressed. Therefore, energy required for cooling may be reduced. In addition, as the flow rate in the external air heating/cooling mode is increased, the cooling efficiency of cooling the high-voltage battery core can be enhanced, the operation range of the external air heating/cooling mode can be widened, and the operation range of the cooling mode in which the air conditioning system is used can be narrowed. Therefore, energy consumption may be reduced, and accordingly the travel distance of the vehicle may be increased.

For convenience in explanation and accurate definition in the appended claims, the terms “upper”, “lower”, “up”, “down”, “upwards”, “downwards”, “internal”, “outer”, “inside”, “outside”, “inwardly”, “outwardly”, “internal”, “external”, “front”, “rear”, “back”, “forwards”, and “backwards” are used to describe features of the exemplar embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described to explain certain principles of the invention and their practical application, to enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A heating, ventilation and air conditioning (HVAC) system for a vehicle, comprising:
an external air cooling line configured to circulate first cooling water through a first radiator, a main valve and a high-voltage battery core;
a cooling/heating line having a first end portion branching from the main valve and a second end portion connected to a downstream point of the high-voltage battery core, the cooling/heating line being configured for the high-voltage battery core to be heated or cooled by a heat exchanger or an electric heater; and
a controller configured to selectively control at least one of the main value, the heat exchanger and the electric heater to cause the first cooling water to circulate through the external air cooling line or the cooling/heating line to perform heat transfer in the heat exchanger or the electric heater when cooling or heating of the high-voltage battery core is needed.

2. The HVAC system according to claim 1, wherein each of the external air cooling line and the cooling/heating line forms an independent flow channel, and the cooling/heating line shares a portion of the external air cooling line including the high-voltage battery core of the external air cooling line to form a closed loop.

3. The HVAC system according to claim 1, wherein the main valve is a three-way valve, and includes a first port on a side of the first radiator, a second port on a side of the cooling/heating line, and a third port on a side of the high-voltage battery core, wherein, when internal cooling and cooling of the high-voltage battery core are simultaneously needed, the controller is configured to perform a control operation to close the first port of the main valve and cause the first cooling water to circulate through the cooling/heating line to transfer heat with the heat exchanger, such that the internal cooling and the cooling of the high-voltage battery core are performed simultaneously.

4. The HVAC system according to claim 1, wherein the main valve is a three-way valve, and includes a first port on a side of a first radiator, a second port on a side of the cooling/heating line, and a third port on a side of the high-voltage battery core, wherein, when a temperature of the high-voltage battery core needs to be raised, the controller is configured to perform a control operation to close the first port of the main valve and cause the first cooling water to circulate through the cooling/heating line to transfer heat with the electric heater, such that cooling of the high-voltage battery core is performed at a same time.

5. The HVAC system according to claim 1, wherein the external air cooling line is provided with a first pump, and the controller is configured to drive or stop the first pump.

6. The HVAC system according to claim 5, wherein the first pump is disposed between a downstream point of the main valve and the second end portion of the cooling/heating line.

7. The HVAC system according to claim 1, wherein the cooling/heating line is configured to transfer heat with an internal air-conditioning refrigerant line through the heat exchanger, wherein the first cooling water having transferred heat with the refrigerant line cools the high-voltage battery core.

8. The HVAC system according to claim 7, wherein the refrigerant line is provided with an auxiliary valve configured for supplying or blocking a refrigerant to allow a refrigerant of the refrigerant line to transfer heat with the first cooling water of the cooling/heating line in the heat exchanger.

9. The HVAC system according to claim 1, wherein the main valve is an on-off valve disposed at the first end portion of the cooling/heating line on a side of the first radiator corresponding to an upstream point of flow of the first cooling water, and is configured to be opened or closed by the controller.

10. The HVAC system according to claim 1, further including:
an electric component cooling line configured to allow second cooling water to independently circulate through a second radiator and an electric component core.

11. The HVAC system according to claim 10, wherein the electric component cooling line is provided with a second pump, and the controller is configured to drive or stop the second pump.

12. The HVAC system according to claim 1, wherein, when a cooling mode is determined, the controller is configured to control the main valve to circulate the first cooling water in the cooling/heating line and to control the first cooling water cooled by heat transfer through the heat exchanger to cool the high-voltage battery core.

13. The HVAC system according to claim 1, wherein, when a heating mode is determined, the controller is configured to control the main valve to circulate the first cooling water in the cooling/heating line and to control the first cooling water heated by heat transfer through the electric heater to raise a temperature of the high-voltage battery core.

14. The HVAC system according to claim 1, wherein, when an external air heating/cooling mode is determined, the controller is configured to control the main valve to circulate the first cooling water in the external air cooling line and controls the first cooling water cooled through a first radiator to cool the high-voltage battery core.
